(19) United States
(12) Patent Application Publication
(10) Pub. No.: US 2007/0156256 A1
(43) Pub. Date: Jul. 5, 2007

(54) Home automation system and method utilizing outdoor environmental conditions

(75) Inventor: Hee Won Jung, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/473,629

(22) Filed: Jun. 23, 2006

(30) Foreign Application Priority Data
Jan. 2, 2006 (KR) 2006-0000195

(51) Int. Cl. G05B 11/01

(52) U.S. Cl. 700/19

(57) ABSTRACT

A home automation system includes one or more electronic appliances for performing home automation operations in response to inputted operation control commands, a smart communicator for inputting condition setting information to be used for control of the electronic appliances, a data collector for repeatedly collecting environmental data corresponding to the condition setting information, and a home server for setting environmental conditions according to the condition setting information inputted from the smart communicator. The home server determines whether collected environmental data match a corresponding environmental condition, and, if the collected environmental data does not match the corresponding environmental condition, controls an associated one of the electronic appliances to operate so that newly collected environmental data matches the corresponding environmental condition.

### CLAIM OF PRIORITY

This application claims priority to an application entitled “HOME AUTOMATION SYSTEM AND METHOD UTILIZING OUTDOOR ENVIRONMENTAL CONDITIONS,” filed in the Korean Intellectual Property Office on Jan. 2, 2006 and assigned Serial No. 2006-0000195, the contents of which are incorporated herein by reference.

### BACKGROUND OF THE INVENTION

1. Field of the Invention

The present invention relates generally to a home automation system and, more particularly, to a home automation system and method wherein individual electric appliances connected to a home network are controlled in accordance with environmental conditions preset or set by remote control of a smart communicator.

2. Description of the Related Art

Various home appliances including washers, refrigerators, televisions and videocassette recorders are utilized in ordinary homes. For user convenience, existing functions of such home appliances have been improved and new functions have been added.

As household affairs become more diversified, a household member tends not to run a particular household affair singly from beginning to end but to run multiple household affairs concurrently. This lengthens rest and leisure time while reducing the time tied up with household affairs.

The desire for a convenient home has resulted in rapid popularization of a home automation system in which home electronic appliances such as lighting fixtures, energy devices, electric devices, security devices and gas devices installed in a household are interconnected through a home network, and controlled and managed by a single entity (home server) in an integrated manner.

FIG. 1 is a block diagram of a conventional home automation system.

As shown in FIG. 1, the home automation system comprises a home server 10 for controlling and managing an overall operation of a home network, and electronic appliances 21, 23, 25, 27, 29 for performing home automation operations according to the control of the home server.

The home server 10 transmits/receives control and operation data to/from the electronic appliances 21, 23, 25, 27 and 29 through wired and/or wireless communication channels. The home server 10 is accessible from an external communication instrument through an Internet network 30, enabling remote control of the electronic appliances 21, 23, 25, 27, 29 through the external communication instrument.

FIG. 2 is a flow chart illustrating an operation control method of electronic appliances using the home automation system of FIG. 1.

Firstly, the home server 10 enters a home automation setting mode in response to an input command (S12). In the home automation setting mode, the home server 10 selects a target appliance whose home automation operation is to be set according to an input command (S14). After selection of the target appliance, the home server 10 sets an operation mode of the selected target appliance according to input operation setting information (S16). The home server 10 stores the operation mode of the target appliance and controls the operation of the target appliance according to the set operation mode (S18).

However, such a conventional home automation system does not specify intelligent operations of electronic appliances in consideration of outdoor environmental conditions, but simply controls specified operations of the electronic appliances. Because the electronic appliances are controlled without special consideration of conditions of the surrounding environment, the electronic appliances may perform improper operations with respect to current conditions and situations at a site where the electronic appliances are located.

In FIG. 1, if, for example, a lighting fixture denoted by reference numeral 21 is set to turn on at 6 P.M., the home server 10 controls the lighting fixture 21 to turn on at 6 P.M. In summer, for example in July, the sun may set after 8 P.M.; hence, it is not necessary to turn on the lighting fixture 21 at 6 P.M. If the home server 10 controls the lighting fixture 21 to turn on at 6 P.M. according to preset operation information without consideration of current environmental conditions, unnecessary waste of energy may be caused.

As another example, assume that the indoor lighting fixture 21 is set to turn on at 8 P.M. Even if the room is dark at 3 P.M. because of thick clouds due to bad weather, the home server 10 will not control the lighting fixture 21 to turn on until 8 P.M. in the evening.

### SUMMARY OF THE INVENTION

The present invention has been made in view of the above problems, and an object of the present invention is to provide a home automation system and method wherein electronic appliances connected to a home network are controlled by remote control of a smart communicator in consideration of outdoor environmental conditions.

Another object of the present invention is to provide a home automation system and method wherein indoor environmental conditions can be set and electronic appliances connected to a home network are adaptively controlled according to the indoor environmental conditions set in advance.

A further object of the present invention is to provide a home automation system and method wherein indoor environmental conditions can be set using a smart communicator, electronic appliances connected to a home network being controlled so as to preserve the indoor environmental conditions set in advance.

In accordance with an embodiment of the invention, there is provided a home automation system that includes one or more electronic appliances for performing home automation operations in response to inputted operation control commands, and a smart communicator for inputting condition setting information to be used for control of the electronic appliances. Further included are a data collector for repeatedly collecting environmental data corresponding to the condition setting information, and a home server for setting environmental conditions according to the condition setting information inputted from the smart communicator. The home server determines whether collected environmental data matches a corresponding environmental condition, and, if the collected environmental data does not match the corresponding environmental condition, controls an associated one of the electronic appliances to operate so that newly collected environmental data matches the corresponding environmental condition.

The data collector preferably includes an indoor data collector installed inside a home to collect indoor environmental data, and an outdoor data collector installed outside the home to collect outdoor environmental data.

The environmental conditions monitored may include at least one of a brightness condition, a humidity condition and a temperature condition. The data collector may include at least one of a brightness sensor, a humidity sensor and a temperature sensor.

Preferably, the home server transmits the collected environmental data to the smart communicator, and resets, if new condition setting information is received from the smart communicator, the environmental conditions according to the new condition setting information.

The smart communicator may feature a long-range communication section for connecting to the home server for long-range communication, a key input section for inputting the condition setting information, a controller for transmitting the condition setting information to the home server through the long-range communication section, and a memory for storing the inputted condition setting information.

The home server preferably has a long-range communication module for receiving the condition setting information from the smart communicator through long-range communication, and a condition setting section for setting the environmental conditions on the basis of the received condition setting information. The home server preferably further features an environmental condition memory for storing the set environmental conditions, an environmental data collector for integrating environmental data collected by the data collector, and a collected data memory for storing the collected environmental data. In a preferred implementation, the home server also has a comparison section for determining whether the collected environmental data matches the corresponding environmental condition, and a controller for controlling, if the collected environmental data does not match the corresponding environmental condition, the associated one of the electronic appliances to operate so that newly collected environmental data matches the corresponding environmental condition.

In accordance with another embodiment of the invention, there is provided a home automation method that includes receiving condition setting information; setting environmental conditions according to the received condition setting information; collecting environmental data on a chosen one of the environmental conditions, the data being controllable by the electronic appliance(s) performing a home automation operations; determining whether the collected environmental data matches the chosen environmental condition; and controlling, if the collected environmental data does not match the chosen environmental condition, at least one of the electronic appliances to operate so that newly collected related environmental data matches the chosen environmental condition.

Preferably, the collecting of environmental data collects environmental data inside an interior space, such as the space interior to a home, and further collects environmental data outside the interior space.

Preferably, the environmental conditions include at least one of a brightness condition, a humidity condition and a temperature condition, and the collected environmental data includes measured data regarding at least one of brightness, humidity and temperature.

The home automation method further comprises the steps of: transmitting the collected environmental data to a smart communicator remotely controlling the home automation operation; determining whether new condition setting information is received from the smart communicator; and resetting, if new condition setting information is received, the environmental conditions according to the new condition setting information.

In a feature of the present invention, environmental conditions are set; environmental data related with a chosen one of the environmental conditions is collected; whether the collected environmental data matches the chosen environmental condition is determined; and, if the collected environmental data does not match the chosen environmental condition, a corresponding electronic appliance is controlled to operate so that newly collected environmental data matches the chosen environmental condition. As a result, electronic appliances connected to a home network can be more efficiently controlled in consideration of appropriate outdoor environmental conditions.

### BRIEF DESCRIPTION OF THE DRAWINGS

The above and other objects, features and advantages of the present invention will be more apparent from the following detailed description taken in conjunction with the accompanying drawings, in which the same reference symbols are given to the same or corresponding elements throughout the several views:

FIG. 1 is a block diagram of a conventional home automation system;

FIG. 2 is a flow chart illustrating an operation control method of electronic appliances using the home automation system of FIG. 1;

FIG. 3 is a block diagram showing an exemplary home automation system that controls operations of electronic appliances corresponding to preset environmental conditions, according to an embodiment of the present invention;

FIG. 4 is a block diagram showing one example of a configuration of a home server in FIG. 3;

FIG. 5 is a block diagram showing an example of a configuration of a smart communicator in FIG. 3;

FIG. 6 is a block diagram showing the configuration of an embodiment of the outdoor data collector of FIGS. 3 and 4;

FIG. 7 is a block diagram showing an embodiment of a configuration of the indoor data collector of FIGS. 3 and 4;

FIG. 8 is a flow chart illustrating a version of a home automation method wherein individual electric appliances are controlled in accordance with preset environmental conditions using the home automation system of FIG. 3, according to another embodiment of the present invention;

FIG. 9 is a flow chart illustrating further steps of the home automation method of FIG. 8 to newly set environmental conditions; and

FIG. 10 is a flow chart illustrating an exemplary application of the home automation method to the control of a humidifier corresponding to a preset humidity condition.

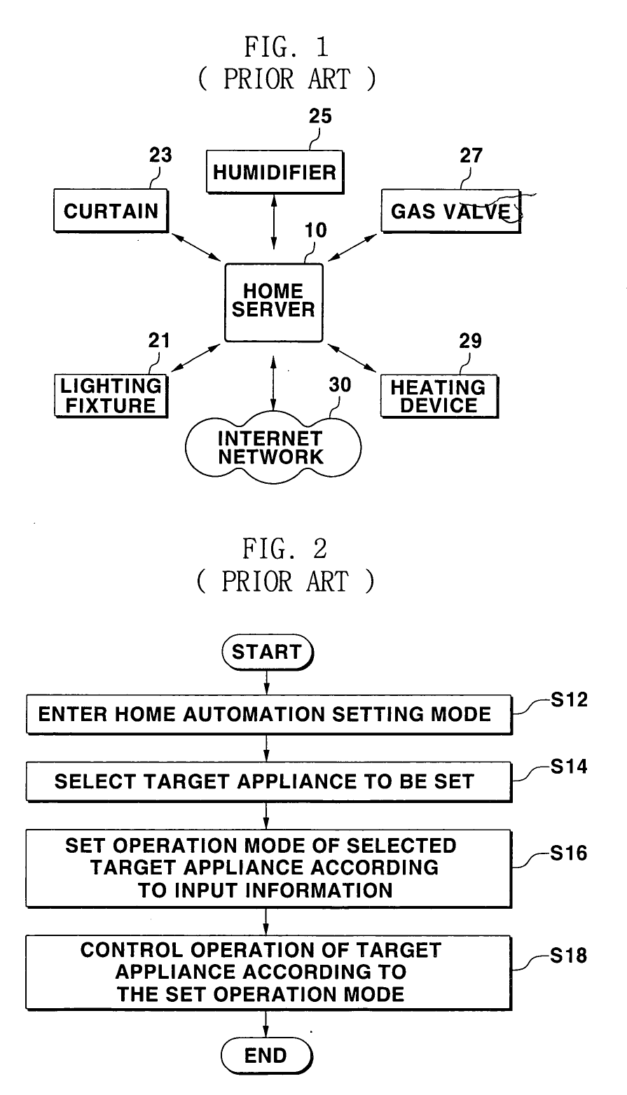

### DETAILED DESCRIPTION OF EXAMPLE EMBODIMENTS

Hereinafter, example embodiments are described in detail with reference to the accompanying drawings. For clarity of presentation, some constructions or processes known in the art are not described or drawn.

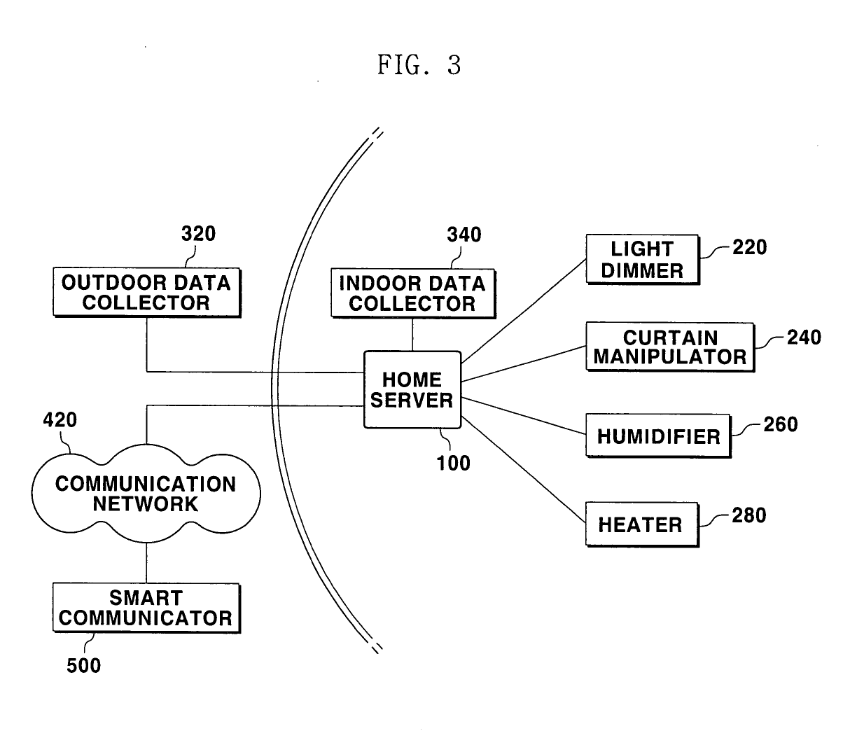

FIG. 3 is a block diagram showing, by way of illustrative and non-limitative example, a home automation system that controls operations of electronic appliances corresponding to preset environmental conditions, according to an embodiment of the present invention.

As shown in FIG. 3, the home automation system comprises a home server 100, electronic appliances 220, 240, 260, 280 connected to a home network (not shown), an outdoor data collector 320, an indoor data collector 340, and a smart communicator 500 for remotely controlling the home server 100 through a communication network 420.

The home server 100 controls operations of electronic appliances 220, 240, 260, 280 connected to the home network according to control commands from the smart communicator 500. In the present embodiment, the home server 100 controls operations of electronic appliances 220, 240, 260, 280 according to environmental conditions preset or transferred from the smart communicator 500 so that the environmental conditions are preserved.

Each of the electronic appliances 220, 240, 260, 280 connected to the home network performs predetermined operations according to the control of the home server 100 so as to preserve a corresponding environmental condition. That is, a light dimmer denoted by reference numeral 220 controls an on/off operation of a lighting lamp and illumination intensity thereof according to the control of the home server 100 so as to meet an illumination condition. A curtain manipulator denoted by reference numeral 240 sets up or takes down a curtain according to the control of the home server 100 so as to meet a brightness condition. A humidifier denoted by reference numeral 260 operates according to the control of the home server 100 so as to meet a humidity condition. A heater denoted by reference numeral 280 operates according to the control of the home server 100 so as to meet a temperature condition.

The outdoor data collector 320 is installed outside the house to gather outdoor data, preferably on the ambient environment of the collector. The data collected pertains to the environmental conditions set in the home server 100. The outdoor data collector 320 transmits the gathered outdoor data to the home server 100. The indoor data collector 340 is installed inside the house to gather indoor data, preferably in the ambient environment of the collector 340 and related with the environmental conditions set in the home server 100. The indoor data collector 340 likewise transmits the gathered indoor data to the home server 100. For example, if a humidity condition is set as an environmental condition set in advance, outdoor humidity data and indoor humidity data may be collected in relation to the humidity condition. Although the home automation system preferably includes both the indoor and outdoor data collectors 340, 320, the system may have merely one of the collectors. Also, the two collectors 340, 320 may be regarded as single, composite collector with two respective ambient environments.

The smart communicator 500 is used to remotely control the home server 100, where a short-range wireless technology such as infrared communication is utilized for indoor communication and a long-range wireless Internet technology such as a wireless broadband (WiBro) technology is utilized for outdoor communication. In the present embodiment, the smart communicator 500 is used to remotely control the home server 100 for setting indoor environmental conditions.

The home server 100 stores the environmental conditions set through the smart communicator 500, and also stores the outdoor data and indoor data received from the outdoor data collector 320 and indoor data collector 340, respectively. The home server 100 determines whether the collected environmental data satisfies a corresponding environmental condition. If the corresponding environmental condition is not satisfied, the home server 100 controls an operation of an associated electronic appliance so that the corresponding environmental condition is satisfied by newly collected environmental data.

If, for example, an indoor humidity condition is set to 80% and measured indoor humidity is 50%, the home server 100 controls the humidifier 260 to operate so that newly measured indoor humidity becomes 80%. In the daytime during fair weather with the sun shining brightly, if a preset indoor brightness condition can be satisfied by opening a curtain, the home server 100 controls the curtain manipulator 240 to open the curtain instead of operating the light dimmer 220. Accordingly, the agent or agents for maintenance of the preset indoor brightness condition are selectively chosen based on the currently existing environmental conditions.

In the present embodiment, environmental conditions are set, and environmental data related with a chosen one of the environmental conditions is gathered to determine whether the gathered environmental data satisfies the chosen environmental condition set in advance. If the chosen environmental condition is not satisfied, a corresponding electronic appliance is controlled to operate so that the chosen environmental condition is satisfied by newly collected environmental data. As a result, it is possible to control home-networked electronic appliances in a more efficient manner according to the environmental conditions.

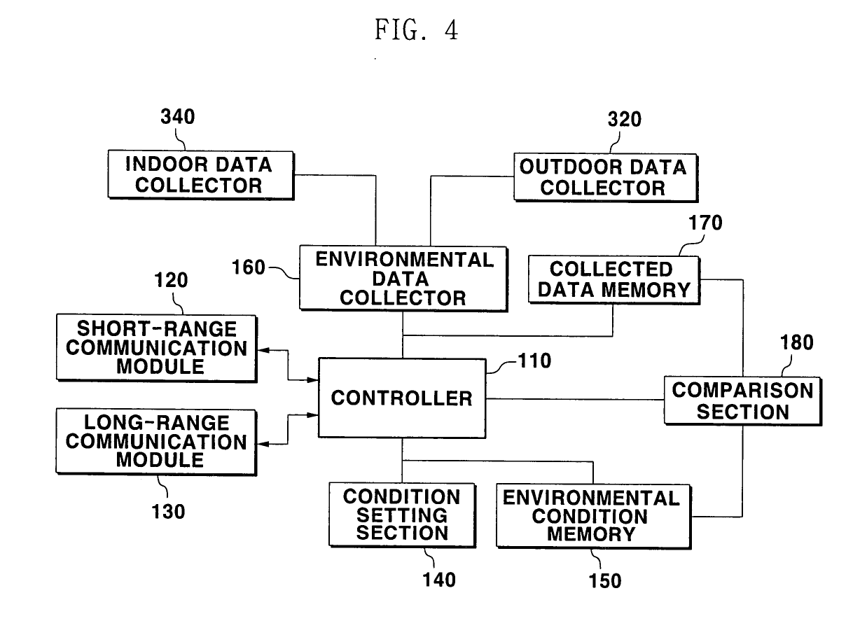

FIG. 4 is a block diagram showing one version of how the home server 100 in FIG. 3 is configured.

As shown in FIG. 4, the home server 100 includes a controller 110, a short-range communication module 120, a long-range communication module 130, a condition setting section 140, an environmental condition memory 150, an environmental data collector 160, a collected data memory 170, and a comparison section 180.

The controller 110 controls an overall operation of the home server 100, and also controls the electronic appliances 220, 240, 260, 280 home-networked to the home server 100. In the present embodiment, the controller 110 controls the electronic appliances 220, 240, 260, 280 to operate so that collected environmental data satisfies the environmental conditions set in advance.

The short-range communication module 120 provides indoor communication connections between the home server 100 and home-networked electronic appliances 220, 240, 260, 280 through short-range wired or wireless communication. The module 120 further provides indoor communication connections between the home server 100 and smart communicator 500 through short-range wireless communication.

The long-range communication module 130 provides a communication connection between the home server 100 and smart communicator 500 through long-range wireless communication. In the present embodiment, the long-range communication module 130 connects to the smart communicator 500 to receive condition setting information and to transmit status information regarding home automation operations of the home server 100.

The condition setting section 140 receives condition setting information from the smart communicator 500 through long or short-range communication, and sets environmental conditions corresponding to the received condition setting information. The environmental condition memory 150 stores the environmental conditions.

The environmental data collector 160 combines environmental data collected by the indoor and outdoor data collectors 340, 320. The environmental data collector 160 may selectively collect indoor or outdoor environmental data related with a particular environmental condition. The collected data memory 170 stores in an integrated manner the indoor and outdoor environmental data collected by the environmental data collector 160. The controller 110 may transmit collected environmental data to the smart communicator 500. Using the received environmental data, the smart communicator 500 may be used to control a corresponding electronic appliance to automatically operate according to an associated environmental condition set in the home server 100, or newly set the associated environmental condition.

The comparison section 180 compares collected environmental data stored in the collected data memory 170 with a corresponding environmental condition stored in the environmental condition memory 150 to determine whether the collected environmental data satisfies the corresponding environmental condition. The comparison section 180 provides the comparison result to the controller 110.

If it is determined from the comparison result that the collected environmental data does not satisfy the corresponding environmental condition, the controller 110 determines whether it is necessary to operate a related electronic appliance. If it is necessary to operate the related electronic appliance, the controller 110 controls the related electronic appliance to operate so that newly collected environmental data satisfies the corresponding environmental condition.

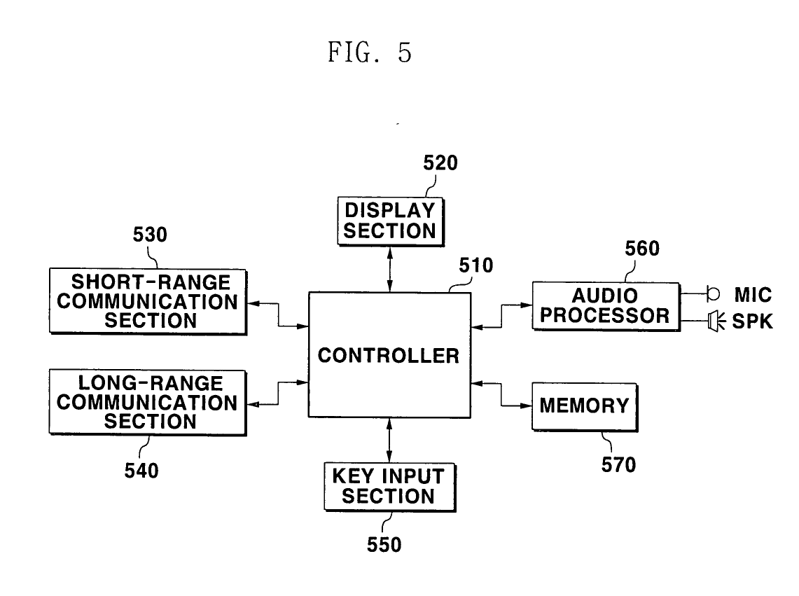

FIG. 5 is a block diagram showing an exemplary configuration of the smart communicator 500 in FIG. 3.

As shown in FIG. 5, the smart communicator 500 includes a controller 510, a display section 520, a short-range communication section 530, a long-range communication section 540, a key input section 550, an audio processor 560, and a memory 570.

The controller 510 controls an overall operation of the smart communicator 500. In the present embodiment, the controller 510 connects to the home server 100 through the communication network 420 to remotely control the operation of the home server 100 and transmit inputted condition setting information.

The display section 520 displays status information regarding operations of the smart communicator 500. In the present embodiment, the display section 520 displays collected environmental data and status information regarding operations of a related electronic appliance, transmitted from the home server 100.

The short-range communication section 530 provides an indoor short-range communication function such as infrared communication to control the operation of the home server 100.

The long-range communication section 540 provides a portable wireless Internet function such as WiBro through the communication network 420. In the present embodiment, the long-range communication section 540 provides an outdoor communication connection between the smart communicator 500 and home server 100 through the communication network 420. The connection affords transmission of condition setting information to the home server 100 and reception of collected environmental data from the home server.

The key input section 550 includes keys for inputting commands to control, through the controller 510, the operation of the smart communicator 500, and to remotely control the operation of the home server 100. In the present embodiment, the keys of the key input section 550 may also be used to input condition setting information.

For voice communication support of the smart communicator 500, the audio processor 560 converts an analog audio signal from a microphone MIC into a digital audio signal according to the control of the controller 510, and also converts a digital audio signal from the controller 510 into an analog audio signal to output the converted analog audio signal through a speaker SPK.

The memory 570 stores programs needed to operate the smart communicator 500, and may also store operation setting information of the home server 100. In the present embodiment, the memory 570 may store condition setting information to be used for controlling the home-networked electronic appliances through the home server 100, and environmental conditions set by the home server 100.

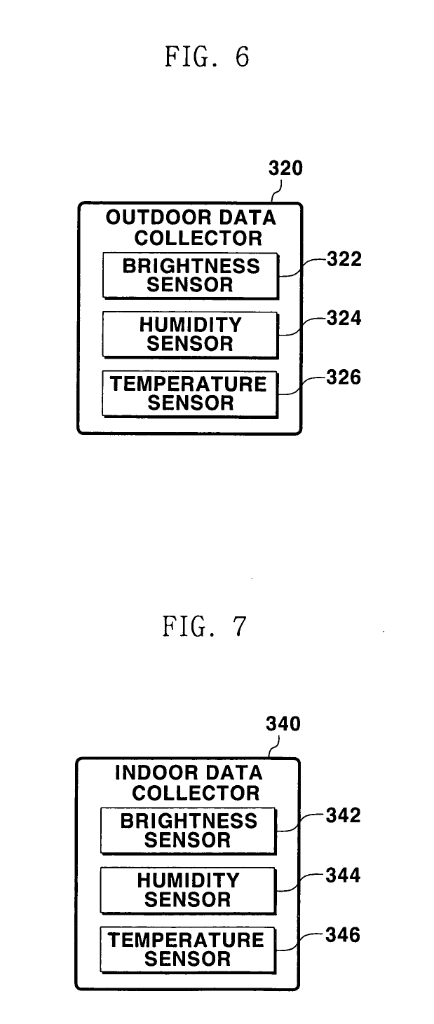

FIG. 6 is a block diagram showing an example of a configuration for the outdoor data collector 320 of FIGS. 3 and 4.

As shown in FIG. 6, the outdoor data collector 320 includes a brightness sensor 322, a humidity sensor 324, and a temperature sensor 326. The outdoor data collector 320 may further include additional sensors for collecting environmental data related with settable environmental conditions.

The brightness sensor 322 measures the outdoor brightness and transmits the measured outdoor brightness to the home server 100. The humidity sensor 324 measures the outdoor humidity and transmits the measured outdoor humidity to the home server 100. The temperature sensor 326 measures the outdoor temperature and transmits the measured outdoor temperature to the home server 100.

FIG. 7 is a block diagram showing one type of configuration applicable to the indoor data collector 340 of FIGS. 3 and 4.

As shown in FIG. 7, the indoor data collector 340 includes a brightness sensor 342, a humidity sensor 344, and a temperature sensor 346. Each sensor of the indoor data collector 340 performs the same operation as that of a corresponding sensor of the outdoor data collector 320.

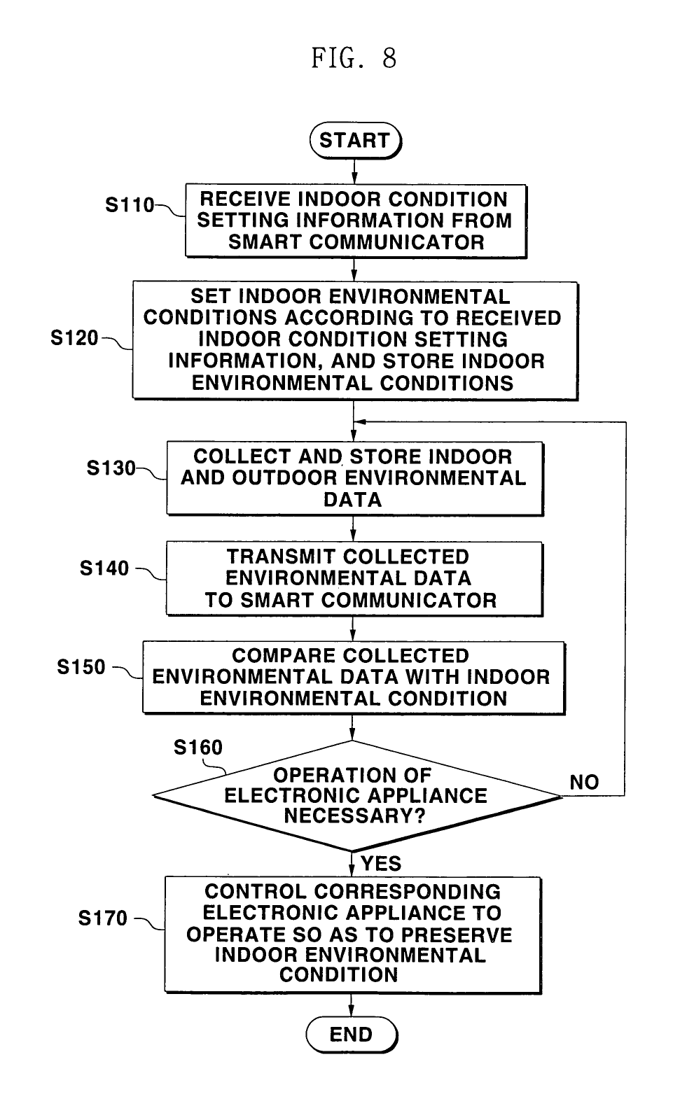

FIG. 8 is a flow chart illustrating a version of a home automation method wherein individual electric appliances are controlled in accordance with preset environmental conditions using the home automation system of FIG. 3, according to another embodiment of the present invention.

Firstly, the home server 100 receives indoor condition setting information from the smart communicator 500 (S110). The home server 100 sets indoor environmental conditions on the basis of the received condition setting information, and stores the set indoor environmental conditions (S120).

The home server 100 then collects outdoor and indoor environmental data through the outdoor data collector 320 and indoor data collector 340, respectively, and stores the collected outdoor and indoor environmental data (S130). The home server 100 transmits the collected outdoor and indoor environmental data to the smart communicator 500 (S140).

The home server 100 compares the collected environmental data with a corresponding indoor environmental condition set in advance (S150) to determine whether it is necessary to operate a related electronic appliance (S160).

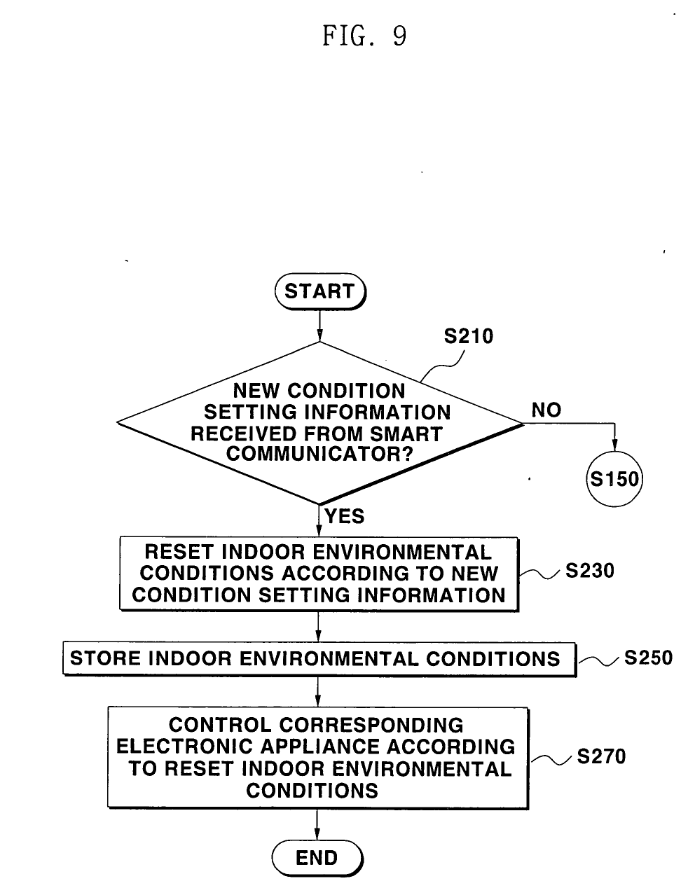

If it is necessary to operate the related electronic appliance, the home server 100 controls the operation of the related electronic appliance so that newly collected environmental data matches the corresponding indoor environmental condition (S170). FIG. 9 is a flow chart illustrating further steps of the home automation method shown in FIG. 8 to newly set the environmental conditions.

Firstly, after transmission of the collected environmental data to the smart communicator 500 at step S140 in FIG. 8, the home server 100 determines whether new condition setting information is received from the smart communicator 500 (S210). If no new condition setting information is received, the method branches to step 150 in FIG. 8.

If new condition setting information is received from the smart communicator 500, the home server 100 newly sets the indoor environmental conditions according to the new condition setting information (S230), and stores the newly set indoor environmental conditions (S250).

The home server 100 then controls operations of the electronic appliances so that the newly set environmental conditions are satisfied by collected environmental data (S270).

Although the first three steps S210-S230 are shown in FIG. 9 to be time-synchronized to the step S140 in FIG. 8, the present invention is not limited to this or any particular synchronization. For example, the steps S210-S230 may, alternatively, run as an autonomous sub-process with the step S210 “NO” branch looping back to “START.” As a further variation, the third to fifth steps S130-S150 shown in FIG. 8 may run as a second, concurrent sub-process, with the sixth and seventh steps S160, S170 running as a third, concurrent sub-process. Accordingly, it is within the intended scope of the invention to implement the embodiment shown in FIGS. 8 and 9 as three, concurrent, ongoing sub-processes.

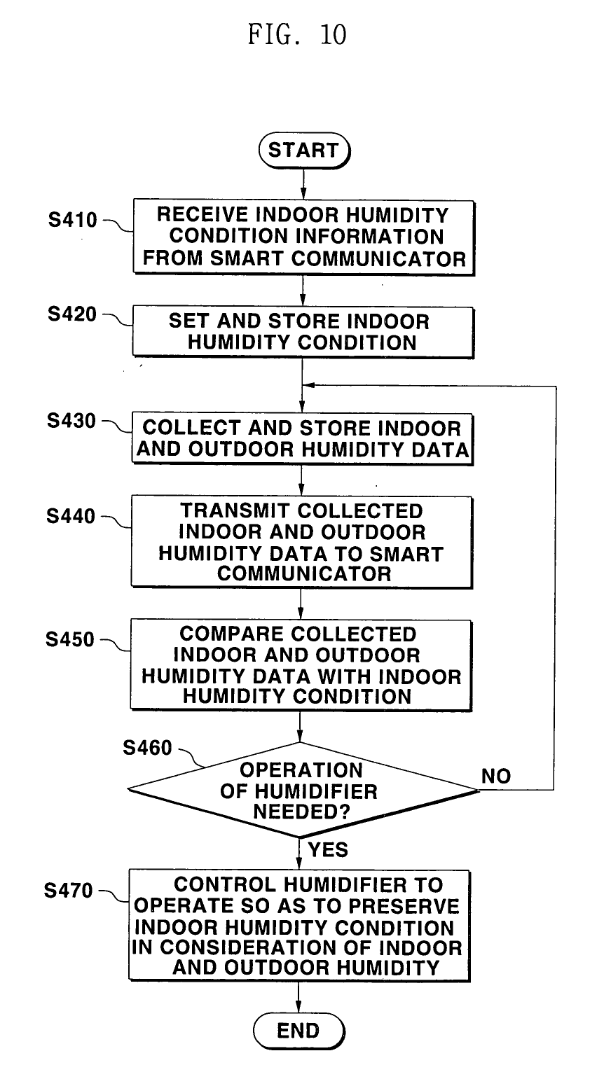

FIG. 10 is a flow chart illustrating an application of the home automation method to the control of the humidifier 260 corresponding to a preset humidity condition.

Firstly, the home server 100 receives indoor humidity condition information from the smart communicator 500 (S410). The home server 100 sets an indoor humidity condition according to the received indoor humidity condition information, and stores the set indoor humidity condition (S420). The home server 100 then collects indoor and outdoor humidity data measured from the indoor and outdoor humidity sensors 344 and 324, respectively, and stores the collected indoor and outdoor humidity data (S430).

The home server 100 transmits the collected indoor and outdoor humidity data to the smart communicator 500 (S440). The home server 100 compares the collected indoor and outdoor humidity data with the indoor humidity condition set in advance (S450) to determine whether it is necessary to operate the humidifier 260 (S460). If it is necessary to operate the humidifier 260, the home server 100 controls the operation of the humidifier 260 so that the indoor humidity condition is preserved in consideration of outdoor humidity (S470).

As apparent from the above description, the present invention aims to provide a home automation system and method wherein environmental conditions are set; environmental data related with a chosen one of the environmental conditions is collected; whether the collected environmental data matches the chosen environmental condition is determined; and, if the collected environmental data do not match the chosen environmental condition, a corresponding electronic appliance is controlled to operate so that newly collected environmental data matches the chosen environmental condition. As a result, electronic appliances connected to a home network can be more efficiently controlled in consideration of appropriate outdoor environmental conditions.

The present invention is disclosed in the preferred embodiments shown in this specification and in the accompanying drawings. This disclosure is not intended to limit the scope of the invention, but to serve only for illustrative purposes. It should be understood by the ordinary person skilled in the art that various changes or modifications of the embodiments are possible without departing from the spirit of the invention.

What is claimed is:

1. A home automation system comprising:
one or more electronic appliances for performing home automation operations in response to inputted operation control commands;
a smart communicator for inputting condition setting information to be used for control of the electronic appliances;
a data collector for repeatedly collecting environmental data corresponding to the condition setting information; and
a home server configured for setting environmental conditions according to the condition setting information inputted from the smart communicator, for determining whether collected environmental data match a corresponding environmental condition, and for controlling, if the collected environmental data does not match the corresponding environmental condition, an associated one of the electronic appliances to operate so that newly collected environmental data matches the corresponding set environmental condition.

2. The home automation system of claim 1, wherein the data collector comprises:
an indoor data collector installed inside a home to collect indoor environmental data; and
an outdoor data collector installed outside the home to collect outdoor environmental data.

3. The home automation system of claim 2, wherein the environmental conditions the home server is configured for setting include at least one of a brightness condition, a humidity condition and a temperature condition.

4. The home automation system of claim 3, wherein said environmental conditions the home server is configured for setting include at least two of a brightness condition, a humidity condition and a temperature condition.

5. The home automation system of claim 2, wherein the data collector includes at least one of a brightness sensor, a humidity sensor and a temperature sensor.

6. The home automation system of claim 5, wherein the data collector includes at least two of a brightness sensor, a humidity sensor and a temperature sensor.

7. The home automation system of claim 2, wherein the home server transmits the collected environmental data to the smart communicator, and resets, if new condition setting information is received from the smart communicator, the environmental conditions according to the new condition setting information.

8. The home automation system of claim 2, wherein the smart communicator comprises:
a long-range communication section for connecting to the home server for long-range communication;
a key input section for inputting the condition setting information;
a controller for transmitting the condition setting information to the home server through the long-range communication section; and
a memory for storing the inputted condition setting information.

9. The home automation system of claim 8, wherein the home server comprises:
a long-range communication module for receiving the condition setting information from the smart communicator through long-range communication;
a condition setting section for setting the environmental conditions on the basis of the received condition setting information;
an environmental condition memory for storing the set environmental conditions;
an environmental data collector for integrating environmental data collected by the data collector;
a collected data memory for storing the collected environmental data;
a comparison section for determining whether the collected environmental data matches the corresponding set environmental condition; and
a controller for controlling, if the collected environmental data does not match the corresponding set environmental condition, the associated one of the electronic appliances to operate so that newly collected environmental data matches the corresponding set environmental condition.

10. A home automation method comprising the acts of:
a) receiving condition setting information;
b) setting environmental conditions according to the received condition setting information;
c) collecting environmental data on a chosen one of the set environmental conditions, the environmental data to be collected on said chosen one being controllable by one or more electronic appliances performing a home automation operation;
d) determining whether the collected environmental data matches the chosen environmental condition; and
e) controlling, if the collected environmental data does not match the chosen environmental condition, at least one of the electronic appliances to operate so that newly collected environmental data on said chosen one matches the chosen environmental condition.

11. The home automation method of claim 10, wherein the act c) includes the acts of:
collecting environmental data inside an interior space; and
collecting environmental data outside the interior space.

12. The home automation method of claim 11, wherein the set environmental conditions include at least one of a brightness condition, a humidity condition and a temperature condition.

13. The home automation method of claim 12, wherein the set environmental conditions include at least two of a brightness condition, a humidity condition and a temperature condition.

14. The home automation method of claim 11, wherein the collected environmental data includes measured data regarding at least one of brightness, humidity and temperature.

15. The home automation method of claim 14, wherein the collected environmental data includes measured data regarding at least two of brightness, humidity and temperature.

16. The home automation method of claim 11, further comprising the steps of:
transmitting the collected environmental data to a smart communicator remotely controlling the home automation operation;
determining whether new condition setting information is received from the smart communicator; and
resetting, if new condition setting information is received, the environmental conditions according to the new condition setting information.

17. The home automation method of claim 10, wherein said collecting of the environmental data is from an ambient environment of a data collector.

18. The home automation system of claim 1, wherein said collecting of the environmental data is from an ambient environment of said data collector.

19. The home automation system of claim 18, further comprising another data collector for repeatedly collecting environmental data corresponding to the condition setting information, wherein said collecting by said another data collector is from an ambient environment of said another collector.

20. The home automation system of claim 19, wherein said data collector and said another data collector are an indoor data collector and an outdoor data collector, respectively.
